(19) United States
(12) Patent Application Publication
(10) Pub. No.: US 2024/0243348 A1
(43) Pub. Date: Jul. 18, 2024

(54) PROCESS FOR PREPARING SOLID-STATE ELECTROLYTES BASED ON FLUORINATED METAL OR SEMIMETAL OXIDES

(71) Applicant: BRETON S.P.A., Castello di Godego (TV) (IT)

(72) Inventors: Luca TONCELLI, Bassano del Grappa (VI) (IT); Fabio BASSETTO, Bolzano Vicentino (VI) (IT); Stefano ZEGGIO, Castagnole di Paese (TV) (IT)

(21) Appl. No.: 18/562,173

(22) PCT Filed: Jun. 20, 2022
(86) PCT No.: PCT/IB2022/055709

§ 371 Date: Nov. 17, 2023

(30) Foreign Application Priority Data
Jun. 21, 2021 (IT) 102021000016082

(51) Int. Cl. H01M 10/0562

(52) U.S. Cl. CPC H01M 10/0562; H01M 2300/0071; H01M 2300/008

(57) ABSTRACT

The present invention refers to a process for preparing a solid-state electrolyte based on fluorinated metal or semimetal oxide particles, to a battery containing said solid-state electrolyte, as well as to a process for producing fluorinated metal or semimetal oxide particles.

### FIELD OF THE INVENTION

The present invention refers to a process for preparing a solid-state electrolyte based on fluorinated metal or semimetal oxide particles, to a battery containing said solid-state electrolyte, as well as to a process for producing fluorinated metal or semimetal oxide particles.

### STATE OF THE ART

A battery, also called a pile or electrochemical cell, is an electrochemical device that converts the energy released by a chemical reaction into electricity.

A battery always consists of two electronic conductors (also called electrodes) in contact with an ionic conductor, called an electrolyte. The electrodes may be liquid or solid, as in the case of lithium batteries; similarly, the electrolyte may also be both solid, such as β-alumina, and liquid, as in most commercial devices.

The operation of a battery is linked to the fact that on the separation surfaces between the electrodes and the electrolyte the conduction of charge carriers passes from electronic to ionic, which can only happen if electrochemical reactions occur. Batteries may be classified into primary or secondary depending on whether the electrochemical discharge reaction occurs in one direction or in both directions, respectively.

Research and industrialization of lithium batteries are due to the high electropositivity and lightness of lithium, which have facilitated the production of systems with high energy density. Primary Li batteries have an anode made of lithium metal, a cathode made of inorganic materials into whose structures lithium can penetrate (the so-called intercalation compounds), of the LiCoO₂, MnO₂, V₂O₅ types, and a solution of a lithium salt (e.g. LiClO₄) in a mixture of organic solvents (for example ethylene carbonate and dimethyl ether) as an electrolyte, as described by Tarascon et. al., Nature 414 (2001) 359-367.

To overcome the cyclability problems inherent to lithium metal (caused by passivation defects at the anode/electrolyte interface), secondary lithium-ion batteries were developed, together with the related anode and cathode intercalation materials, as reported by Thackeray et al., Material Research Bulletin 18 (1983), 461-472. A typical cathode intercalation material is LiCoO₂ (lithium cobaltate); much studied (Padhi et. al Journal of the Electrochemical Society 144 (1997) 1609-1613) are the poly-oxoanionic compounds having a structure consisting of octahedra of the MO₆ type, with M=Fe, Ti, V, Nb, and tetrahedral anions of the XO₄ⁿ⁻ type with X=S, P, As, Mo and W; among these the main one is LiFePO₄. A typical anode intercalation material is graphite.

The purpose of the electrolytes is to allow the passage of charge carriers (such as Li⁺) from the anode to the cathode; electrolytes must have some characteristics:
High ionic conductivity;
wide electrochemical stability window, necessary if cathode materials which are particularly oxidizing with respect to Li/Li⁺ (>4 V) are used;
high thermal stability, required for high temperature batteries.

Electrolytes may be divided into four main categories based on their physical state (Gray, Polymer Electrolytes, RSC Material Monographs, Cambridge, 1997):
1) liquid electrolytes: consisting, for example, of a solution of a lithium salt dissolved in a solvent (Galinsky et al. Electrochimica Acta 51 (2006) 5567-5580). Despite their high conductivity (values comprised between 10⁻² and 10⁻³ S cm⁻¹), liquid electrolytes have numerous disadvantages: they cause losses and corrosion problems, do not allow use at high temperatures due to their volatility, and, finally, severely limit the miniaturization of devices
2) solid-ceramic electrolytes: in which conductivity occurs thanks to the movement of charge point defects; they are usually used for high temperature systems and may be classified into three categories of chemical compounds:
a. perovskite-type oxides (as described by P. Knauth, Solid State Ionics, 180 (2009) 911-916); currently the best Li ion ceramic conductor is based on a lanthanum titanate where, at temperatures not higher than 127° C., Li⁺ is expected to move in the solid solution through lanthanum vacancies;
b. sulfides (materials such as Thio-LISICON, described by M. Murayama et al. Journal of Solid State Chemistry 168(1) (2002)140); and
c. phosphates (materials such as NASICON, described by P. Knauth, op. cit.).
3) solid-glass electrolytes: these are amorphous solids obtainable by cooling from liquids; at room temperature the conductivity values are comprised between 10⁻² and 10⁻⁵ S cm⁻¹.
4) molten electrolytes: made up of eutectic mixtures of molten salts, they are used in high temperature Li batteries, such as the LiCl/KCl mixture, whose eutectic point is at 355° C. The main disadvantage lies in the need to keep the device at a high temperature, and in the use of very aggressive reagents.

These first four categories of electrolytes have a common disadvantage, namely liquid electrodes such as molten metals (sodium) or molten salts (NaSx) have to be provided in order to ensure constant contact between electrodes and electrolyte.

Polymer electrolytes appear to be possible candidates for making all-solid state devices. This family embraces several subsets of materials:
a. gel electrolytes, wherein the lithium salt is dissolved in a polar liquid to which an inert polymeric material is subsequently added to provide greater stability;
b. plasticized electrolytes, wherein a liquid with a high dielectric constant is added to a polymeric electrolyte to improve its conductivity;
c. “ionic rubbers” which are obtained by adding a high molecular weight polymer to a liquid electrolyte;
d. membranes with ionic conductivity, similar to those used in fuel cells;
e. organic-inorganic hybrid electrolytes. The basic structure of these materials consists of a series of organic macromolecules (for example, polyethylene oxide, PEO) which act as a bridge to inorganic species. Examples of organic-inorganic hybrids are 3D-HION-APEs (three-dimensional hybrid inorganic-organic networks as polymer electrolytes), Z-IOPEs (zeolites inorganic-organic polymer electrolytes), and HGEs (hybrid gel electrolytes).

The article by Sagua A. et Al. Solid State Ionics 177(2006): 1099-1104 describes the preparation of a solid-state electrolyte starting from iron oxychloride which is lithiated with n-butyllithium.

WO 2013/011423 describes the use of particles of at least one crystalline oxide, preferably a metallic oxide, having an average particle size lower than 500 nm and a fluorine content comprised between 0.5 and 30% by weight, preferably between 0.5 and 5%, even more preferably between 1.0 and 4%, in the preparation of solid-state electrolytes.

A solid-state electrolyte is also described, consisting of particles of at least one crystalline oxide, preferably a metallic oxide, having an average particle size lower than 500 nm, preferably comprised between 10 and 500 nm, even more preferably between 50 and 300 nm; a fluorine content comprised between 0.5 and 30% by weight, preferably between 0.5 and 5%, even more preferably between 1 and 4%; an alkali or alkaline earth metal content comprised between 0.5 and 10% by weight, preferably between 0.5 and 5%, even more preferably between 1 and 4%.

An inorganic-organic hybrid electrolyte, which can be obtained by reacting the aforementioned solid-state electrolyte with ionic liquids, is also described.

### OBJECT OF THE INVENTION

An object of the present invention is to provide a new process for preparing solid-state electrolytes starting from fluorinated metal or semimetal oxide particles which is more advantageous than that described in the International Patent Application WO 2013/011423, in terms of steps simplification, as well as of lower reaction duration and temperature.

Another object of the present invention is to provide a new process for producing fluorinated metal or semimetal oxide particles starting from metal or semimetal particles which is simpler than that described in the International Patent Application WO 2013/011423.

The electrolytes of the present invention also has to be characterized by conductivity values comparable with those of solid-state electrolytes already established and present on the market.

Therefore, in a first aspect thereof, the present invention relates to a process for preparing a solid-state electrolyte according to claim 1.

In accordance with a second aspect thereof, the present invention relates to a solid-state electrolyte obtainable according to the process of the invention.

In accordance with a third aspect thereof, the present invention relates to an inorganic-organic hybrid electrolyte obtainable by reaction of a solid-state electrolyte according to the invention with an ionic liquid.

In accordance with a fourth aspect thereof, the present invention relates to a battery containing a solid-state electrolyte or an inorganic-organic hybrid electrolyte according to the invention.

In accordance with a fifth aspect thereof, the present invention relates to a process for producing fluorinated metal or semimetal oxide particles according to claim 16.

In accordance with a sixth aspect thereof, the present invention relates to the fluorinated metal or semimetal oxide particles obtainable according to the process of the present invention.

In accordance with a seventh aspect thereof, the present invention relates to the use of said fluorinated metal or semimetal oxide particles for preparing solid-state electrolytes.

### Definitions

Unless otherwise defined, all terms of the art, notations, and other scientific terms used herein are intended to have the meanings commonly understood by those skilled in the art to which this description belongs. In some cases, terms with meanings that are commonly understood are defined herein for clarity and/or ready reference; therefore, the inclusion of such definitions in the present description should not be construed as being representative of a substantial difference with respect to what is generally understood in the art.

The terms “approximately” and “about” used in the text refer to the range of the experimental error that is inherent in the execution of an experimental measurement.

The terms “comprising”, “having”, “including” and “containing” are to be intended as open-ended terms (i.e., meaning “comprising, but not limited to”), and are to be considered as a support also for terms such as “consist essentially of”, “consisting essentially of”, “consist of”, or “consisting of”.

The terms “consist essentially of”, “consisting essentially of” are to be intended as semi-closed terms, meaning that no other ingredients affecting the novel features of the invention are included (optional excipients may therefore be included i).

The terms “consists of”, “consisting of” are to be intended as closed terms.

The term “room temperature” refers to a temperature comprised between 15° C. and 25° C., preferably between 20° C. and 25° C.

The term “relative pressure” refers to a pressure where zero is attributed to atmospheric pressure (1 atm=101325 Pa).

The term “overnight” refers to the duration of an experiment that takes place during the night (therefore for an average time of 12-15 hours).

The term “fluorinated semimetal oxide” used in the text preferably refers to fluorinated silicon oxide.

### DETAILED DESCRIPTION OF THE INVENTION

More particularly, the present invention relates to a process for preparing a solid-state electrolyte comprising the following steps:
(i) pre-dispersing fluorinated metal or semimetal oxide particles in an organic solvent;
(ii) reacting the dispersion thus obtained with a solution of at least one organometallic compound at room temperature, preferably for a time period comprised between 1 minute and 10 hours, more preferably between 10 minutes and 1 hour;
(iii) separating the liquid phase from the solid phase;
(iv) washing the solid phase thus obtained with an organic solvent to remove the excess unreacted organometallic compound;
(v) drying the solid obtained from step (iv) at a temperature of at least 20° C., preferably between 60 and 100° C.

Even more preferably the drying step (v) is carried out under vacuum.

It was found that thanks to the aforementioned specific characteristics of the process for preparing a solid-state electrolyte according to the invention, in particular thanks to the use of an organometallic compound, it is possible to achieve a series of very advantageous technical effects compared to the use of the molten metal described in the International Patent Application WO 2013/011423, including:
Carry out the reaction at room temperature, preferably at a temperature between 15° C. and 25° C.;
Use glass-based reactors, and thus simplify the choice of reactor construction materials;
Obtain a much faster reaction (a few minutes compared to a few hours);
Manage the stoichiometry between fluorinated oxide/organometallic reagents.

In general, a stoichiometric amount of organometallic reagent is used with respect to the lithium concentration present in the final electrolyte.

Preferably, the organic solvent of step (i) and (iv) is an aprotic solvent, more preferably independently selected from the group comprising n-hexane, heptane, octane, iso-octane, benzene, toluene, ethyl-benzene, diethyl ether, dimethyl ether, ethyl methyl ether, tetrahydrofuran, and mixtures thereof.

In a preferred embodiment of the process for preparing an electrolyte according to the invention, the organometallic compound referred to in step (ii) is based on lithium, sodium or magnesium, preferably said organometallic compound is selected from n-butyllithium, methyllithium, ethyllithium, sec-butyllithium, isopropyllithium, propyllithium, tert-butyllithium, phenyllithium, n-butylsodium, methylsodium, sec-butylsodium, isopropylsodium, ethylsodium, propylsodium, tert-butylsodium, phenylsodium, Grignard reactants, preferably selected from ethylmagnesium chloride, methylmagnesium chloride, allylmagnesium chloride, or mixtures thereof.

In a preferred embodiment of the process for preparing the electrolyte according to the invention, said fluorinated metal or semimetal oxide particles are obtained by a process comprising the following steps:
(a) a raw material containing a metal or a semimetal is reacted with an aqueous solution containing at least one fluorinating agent;
(b) a basic aqueous solution is added to the aqueous solution containing fluorometalates thus obtained, which causes the precipitation of oxyfluorometalates;
(c) the aqueous dispersion thus obtained is filtered with subsequent separation of a solid residue;
(d) the solid residue thus obtained is subjected to a hydrothermal treatment in a vapor atmosphere at a relative pressure between 0.01 bar and 10 bar, and at a temperature between 350° C. and 500° C., preferably for a time period between 0.5 and 24 hours, thereby obtaining the fluorinated metal or semimetal oxide particles.

Preferably, said raw material is selected from metal or semimetal particles, preferably selected from titanium, iron, copper, silicon and zinc, minerals comprising said metals or semimetal, or mixtures thereof. More preferably, said raw material is selected from metal or semimetal particles.

It was advantageously found that the use of titanium or iron metal particles as compared to minerals, such as ilmenite (FeTiO₃), used in the International Patent Application WO 2013/011423, is advantageous because it is not necessary to carry out the separation of Fe or Ti (contained in ilmenite) to obtain Ti-only or Fe-only compounds.

Preferably, the process according to the invention is characterized by the fact that said at least one fluorinating agent is selected from hydrofluoric acid, NH₄HF₂, NH₄F, or mixtures thereof.

In a preferred embodiment of the process according to the invention, step (a) is carried out at a temperature between 30° C. and 105° C., preferably for a time between 0.5 and 10 hours.

In a further preferred embodiment of the process according to the invention, step (b) is carried out until a pH between 8 and 11 is reached, preferably by adding an ammonia solution at a concentration from 1 to 30%. More preferably, a solution of ammonia at a concentration of 30%.

Preferably, the vapor referred to in step (d) is generated by vaporizing a fluorinated aqueous solution containing said at least one fluorinating agent and an amount of H₂O comprised between 60% and 100%, or pure H₂O.

In a preferred embodiment, the process according to the invention is characterized in that it comprises a further step (e), wherein the aqueous solution obtained from step (c) is subjected to a concentration treatment by evaporation to be recycled in step (a).

It was found that the hydrothermal treatment determines the decomposition of oxyfluorometalates, and the formation of oxides appropriately doped with F (and N).

The fluorine complex obtained is inserted inside a ceramic tube and the vapor phase is fed at a relative pressure between 0.01 bar and 10 bar.

Since the decomposing fluorine complexes generate HF and NH₃, it follows that these partial pressures are determined by: a) fluorine complex/ceramic tube volume mass ratio and b) composition of the fed vapor. Therefore, depending on the value of a), it is possible to obtain the suitable fluorinated oxide by appropriately modifying the composition of the vapor injected during pyrohydrolysis; it is possible to vaporize aqueous fluorinated solutions or pure H₂O.

The present invention also relates to a solid-state electrolyte obtainable according to the process of the present invention.

In particular, the electrolyte may be used as such, or it can be reacted with ionic liquids to increase the conductivity by obtaining an inorganic-organic hybrid electrolyte.

In a further aspect thereof, the present invention relates to an inorganic-organic hybrid electrolyte obtainable by reaction of a solid-state electrolyte according to the present invention with an ionic liquid.

Ionic liquids are salts with melting temperatures so low that they are liquid at room temperature, preferably at a temperature comprised between 20 and 25° C., as for example described in Galinski et al., Electrochimica Acta, 51 (2006) 5567-5580.

Among the ionic liquids that can be used for the purposes of the present invention, there are those obtainable from imidazolium, ammonium, pyridinium, piperidinium, pyrrolidinium, sulfonium and cholinium cations, such as for example 1-ethyl-3-methylimidazolium [EtMelm]⁺, trimethylpropylammonium [TMePrA]⁺, N-methyl-N-propylpyridinium [MePrPi]⁺, N-methyl-N-propylpiperidinium [MePrPp]⁺, 1-butyl-1-methylpyrrolidinium [BuMePi], triethyl-sulfonium, cholinium acetate, and from bis-trifluoromethyl-sulfonylimide [TFSI]⁻, tetra-fluoroborate [BF₄]⁻, hexa-fluorophosphate [PF₆]⁻ anions.

The reaction with ionic liquids takes place by mixing, preferably in a ball mill, from 20 to 1 parts by weight of solid-state electrolyte particles, preferably from 8 to 2 parts by weight, with one part by weight of ionic liquid. The reaction preferably takes place at room temperature, more preferably at a temperature between 20 and 25° C., operating in an inert gas atmosphere, preferably in an argon atmosphere. Preferably it is carried out for 0.5-2 hours, even more preferably for 1 hour. It should be borne in mind that during mechanical mixing the system temperature increases; so, at the beginning the system is at room temperature, after the time required for mixing the system temperature can reach a temperature of 70-80° C.

The present invention also relates to a battery containing a solid-state electrolyte or an inorganic-organic hybrid electrolyte according to the present invention. The solid-state electrolytes of the invention may therefore be used in batteries, preferably in secondary high temperature lithium batteries, sodium, or magnesium batteries.

The present invention also relates to a process for producing fluorinated metal or semimetal oxide particles comprising the following steps:
(a) metal or semimetal particles are reacted with an aqueous solution containing at least one fluorinating agent;
(b) a basic aqueous solution is added to the aqueous solution containing fluorometalates thus obtained, which causes the precipitation of oxyfluorometalates;
(c) the aqueous dispersion thus obtained is filtered with subsequent separation of a solid residue;
(d) the solid residue thus obtained is subjected to a hydrothermal treatment in a vapor atmosphere, at a relative pressure between 0.01 bar and 10 bar, and at a temperature between 350° C. and 500° C., preferably for a time period between 0.5 and 24 hours, thereby obtaining the fluorinated metal or semimetal oxide particles.

Preferably, said metal or semimetal particles are selected from titanium, iron, copper, silicon, and zinc.

It was advantageously found that the use of titanium or iron metal particles as compared to minerals, such as ilmenite (FeTiO₃), used in the International Patent Application WO 2013/011423, is advantageous because it is not necessary to carry out the separation of Fe or Ti (contained in ilmenite) to obtain Ti-only or Fe-only compounds.

The use of metal or semimetal particles therefore allows the simplification of the production process of pure fluorinated oxides as compared to the already known processes.

Preferred embodiments of the process for producing fluorinated metal oxide or semimetal particles are described above in the process for preparing a solid-state electrolyte according to the invention.

The present invention relates to particles of fluorinated metal or semimetal oxide obtainable according to the process of the present invention.

The present invention also relates to the use of said fluorinated metal or semimetal oxide particles for preparing solid-state electrolytes.

The following examples are intended to further illustrate the invention without however limiting it.

### Example 1

### Production of F-Doped Ti Oxide

1 liter of ultra-pure water, 40 g of titanium metal powder and 428 g of NH₄HF₂ are poured into a container with a suitable capacity. The addition of the salt occurs slowly because hydrogen gas is generated. The dispersion is then heated to 70° C. overnight. The container is left to rest for two days at 60° C. Filtration follows to separate the unreacted metal residues. About 300 ml of a 30% ammonia solution are gradually added to 1 liter of filtered solution until a pH of about 8.6 is reached, thus obtaining the precipitation of a white compound, a mixture of ammonium oxy-fluorotitanates. Filtration follows. 30 grams of filtered solid are placed inside a ceramic tube. The tube is then heated up to 375° C. with a heating rate of 10° C./min for 2 hours. During the heat treatment, steam generated from pure water is blown in with an average weight flow rate of 75 g/h with a relative total pressure (air+steam) of approximately 0.2 bar. The resulting solid was analyzed by SEM with energy dispersion microanalysis (SEM-EDS) whose results are reported in Table 1.

### Example 2

### Production of F-Doped Ti Oxide by Vaporization of a NH₄F Aqueous Solution

The oxide is obtained by following the procedure of Example 1 with the only difference that, during the heat treatment, steam generated by a 10% NH₄F aqueous solution (and not pure H₂O) is blown in. The resulting solid is analyzed by SEM-EDS, whose results are reported in Table 1.

### Example 3

### Production of F-Doped Fe Oxide

1 liter of ultra-pure water, 40 g of powdered iron metal powder and 428 g of NH₄HF₂ are poured into a container with a suitable capacity. The addition of the salt is performed slowly because hydrogen gas is generated. The dispersion is then heated to 70° C. overnight. The container is left to rest for two days at 60° C. Filtration follows to separate the unreacted metal residues. About 300 mL of a 30% ammonia solution is added to 1 liter of the filtered solution, thus obtaining the precipitation of a mixture of ammonium oxyfluoroferrates. Filtration follows. 30 grams of filtered solid are placed inside a ceramic tube. The tube is then heated up to 375° C. with a heating rate of 10° C./min for 2 hours. During the heat treatment, steam generated from pure water is blown in with an average weight flow rate of 75 g/h with a relative total pressure (air+steam) of approximately 0.2 bar. The resulting dark red solid is analyzed by SEM-EDS, whose results are reported in Table 1.

### Example 4

### Production of F-Doped Silicon Oxide

1 liter of ultra-pure water and 428 g of NH₄HF₂ are poured into a container with a suitable capacity and heated to 70° C. 100 g of (NH₄)₂SiF₆ are poured into the solution. The solution is left to rest for two days at 60° C. About 300 ml of a 30% ammonia solution is added to 1 liter of the solution, thus obtaining the precipitation of a mixture of ammonium oxyfluorosilicates. Filtration follows. 30 grams of filtered solid are placed inside a ceramic tube. The tube is then heated up to 375° C. with a heating rate of 10° C./min for 2 hours. During the heat treatment, steam generated from pure water is blown in with an average weight flow rate of 75 g/h with a relative total pressure (air+steam) of approximately 0.2 bar. The resulting solid was analyzed by SEM-EDS, whose results are reported in Table 1.

TABLE 1

| | Example 1 | Example 2 | Example 3 | Example 4 |
|---|---|---|---|---|
| M (MOₓ) = | Ti | Ti | Fe | Si |
| F, wt % = | 2.88 | 10.44 | 19.55 | 3.92 |
| M, wt % | 62.59 | 55.35 | 55.94 | 47.69 |
| O, wt. % | 27.49 | 34.21 | 17.03 | 48.04 |

The complement to 100% is due to metallic impurities deriving from the raw materials.

### Example 5

Li Ion Electrolyte from F-Doped Ti Oxide

Titanium oxide obtained as in Example 1 is vacuum dried at 10⁻¹ mbar, at 70° C. for a time of at least 12 hours. After drying, 1.144 g of oxide are pre-dispersed in anhydrous hexane (H₂O content <10 ppm) for a few minutes. 56 mL of a n-butyllithium solution are poured dropwise, under stirring, into the oxide/hexane dispersion. The reaction takes place at room temperature. The powder changes in color from a faint yellow to a dark purple after a few minutes. It is left under stirring for the time necessary for all the initial oxide particles to react, passing from a yellow to a purplish color. At the end of the reaction, the dispersion is filtered and the solid washed at least 3 times with clean anhydrous hexane. After the last washing, the powder is dried at 70° C. and 10⁻¹ mbar of residual pressure. The conductivity value is equal to approximately 1.8×10⁻⁴ S cm⁻¹, when measured at room temperature.

### Example 6

Li Ion Electrolyte from F-Doped Fe

Iron oxide obtained as in Example 3 is vacuum dried at 10⁻¹ mbar, at 70° ° C. for a time of at least 12 hours. After drying, 547 g of oxide are pre-dispersed in anhydrous hexane (H₂O content <10 ppm) for a few minutes. 20 mL of n-butyllithium solution are poured dropwise, under stirring, into the oxide/hexane dispersion. The reaction takes place at room temperature. The powder changes in color from a faint yellow to a dark purple after a few minutes. It is left under stirring for the time necessary for all the initial oxide particles to react, passing from a yellow to a purplish color. At the end of the reaction, the dispersion is filtered and the solid washed at least 3 times with clean anhydrous hexane. After the last washing, the powder is dried at 70° C. at 10⁻¹ mbar of residual pressure. The conductivity value is equal to approximately 1.2×10⁻⁴ S cm⁻¹, when measured at room temperature.

### Example 7

Na Ion Electrolyte from F-Doped Ti Oxide

Butyl chloride is reacted slowly, at low temperature, under an inert atmosphere, with metal sodium flakes, and butyl-sodium and a NaCl precipitate are formed in anhydrous hexane solvent. The butyl-sodium solution is used for sodiation of the Ti oxide described in Example 1. About 500 mg of oxide are pre-dispersed in hexane, and butyl-Na is added dropwise at room temperature. The reaction is carried out under an argon atmosphere (oxygen and water <1 ppm). Once the reaction is completed, after about 15 minutes, the product is separated from the liquid phase and washed abundantly with hexane. With this method it is possible to functionalize the fluorinated oxides with sodium. After the last washing, the powder is dried at 70° C. at a pressure of 10⁻¹ mbar. The conductivity value is equal to approximately 10⁻⁴ s cm⁻¹ when measured at room temperature.

1. A process for preparing a solid-state electrolyte, comprising the following steps:
(i) pre-dispersing fluorinated metal or semimetal oxide particles in an organic solvent;
(ii) reacting the dispersion thus obtained with a solution of at least one organometallic compound at room temperature;
(iii) separating the liquid phase from the solid phase;
(iv) washing the solid phase thus obtained with an organic solvent to remove the excess unreacted organometallic compound; and
(v) drying the solid obtained from step (iv) at a temperature of at least 20° C.

2. The process for preparing an electrolyte according to claim 1, characterized in that the organic solvent referred to in step (i) and (iv) is an aprotic solvent, preferably independently selected from the group comprising n-hexane, heptane, octane, iso-octanes, benzene, toluene, ethylbenzene, diethyl ether, dimethyl ether, ethyl methyl ether, tetrahydrofuran, and mixtures thereof.

3. The process for preparing an electrolyte according to claim 1, characterized in that the organometallic compound referred to in step (ii) is based on lithium, sodium or magnesium, wherein said organometallic compound is selected from n-butyllithium, methyllithium, ethyllithium, sec-butyllithium, isopropyllithium, propyllithium, tert-butyllithium, phenyllithium, n-butylsodium, methylsodium, sec-butylsodium, isopropylsodium, ethylsodium, propylsodium, tert-butylsodium, phenylsodium, or Grignard reactants selected from ethylmagnesium chloride, methylmagnesium chloride, allylmagnesium chloride, or mixtures thereof.

4. The process for preparing an electrolyte according to claim 1, characterized in that the drying referred to in step (v) is carried out under vacuum.

5. The process for preparing an electrolyte according to claim 1, characterized in that said fluorinated metal or semimetal oxide particles are obtained by a process comprising the following steps:
(a) a raw material containing a metal or a semimetal is reacted with an aqueous solution containing at least one fluorinating agent;
(b) a basic aqueous solution is added to the aqueous solution containing fluorometalates thus obtained, which causes the precipitation of oxyfluorometalates;
(c) the aqueous dispersion thus obtained is filtered with subsequent separation of a solid residue; and
(d) the solid residue thus obtained is subjected to a hydrothermal treatment in a vapor atmosphere at a relative pressure between 0.01 bar and 10 bar and at a temperature between 350° C. and 500° C., for a time period between 0.5 and 24 hours, thereby obtaining the fluorinated metal or semimetal oxide particles.

6. The process for preparing an electrolyte according to claim 5, characterized in that said raw material is selected from metal or semimetal particles, selected from titanium, iron, copper, silicon and zinc, minerals comprising said metals or semimetals, or mixtures thereof.

7. The process for preparing an electrolyte according to claim 5, characterized in that said at least one fluorinating agent is selected from hydrofluoric acid, NH₄HF₂, NH₄F or mixtures thereof.

8. The process for preparing an electrolyte according to claim 5, characterized in that said step (a) is carried out at a temperature between 30° C. and 105° C. for a time period between 0.5 and 10 hours.

9. The process for preparing an electrolyte according to claim 5, characterized in that said step (b) is carried out until a pH between 8 and 11 is reached by adding an ammonia solution at a concentration of 1 to 30%.

10. The process for preparing an electrolyte according to claim 5, characterized in that the vapor referred to in step (d) is generated by vaporizing a fluorinated aqueous solution containing said at least one fluorinating agent and an amount of H₂O comprised between 60% and 100%, or pure H₂O.

11. The process for preparing an electrolyte according to claim 5, characterized in that said process comprises a further step (e), wherein the aqueous solution obtained from step (c) is subjected to a concentration treatment by evaporation to be recycled in step (a).

12. A solid-state electrolyte obtainable by the process according to claim 1.

13. An inorganic-organic hybrid electrolyte obtainable by reacting a solid-state electrolyte according to claim 12 with an ionic liquid.

14. The inorganic-organic hybrid electrolyte according to claim 13, characterized in that said ionic liquid is selected from those obtainable from imidazolium, ammonium, pyridinium, piperidinium, pyrrolidinium, sulfonium and cholinium cations, and from bis-trifluoromethyl-sulfonylimide [TFSI]-, tetrafluoroborate [BF4]-, hexafluorophosphate [PF6]-anions.

15. A battery containing a solid-state electrolyte according to claim 12 or an inorganic-organic hybrid electrolyte according to claim 13.

16. A process for producing fluorinated metal or semimetal oxide particles including the following steps:
(a) metal or semimetal particles are reacted with an aqueous solution containing at least one fluorinating agent;
(b) a basic aqueous solution is added to the aqueous solution containing fluorometalates thus obtained, which causes the precipitation of oxyfluorometalates;
(c) the aqueous dispersion thus obtained is filtered with subsequent separation of a solid residue;
(d) the solid residue thus obtained is subjected to a hydrothermal treatment in a vapor atmosphere at a relative pressure between 0.01 bar and 10 bar, and at a temperature between 350° C. and 500° C., thereby obtaining the fluorinated metal or semimetal oxide particles.

17. The process according to claim 16, characterized in that said metal particles are selected from titanium, iron, copper, silicon, and zinc.

18. The process for producing fluorinated metal or semimetal oxide particles according to claim 7.

19. Fluorinated metal or semimetal oxide particles obtainable according to the process of claim 16.

20. A use of fluorinated metal or semimetal oxide particles according to claim 19, for preparing solid-state electrolytes.

21. The process for preparing a solid-state electrolyte according to claim 1, wherein the step of reacting the dispersion is for a time period comprised between 10 minute and 1 hours

22. The process for preparing a solid-state electrolyte according to claim 1, wherein the step of drying the solid is at a temperature of between 60 and 100° C.

23. The process for producing fluorinated metal or semimetal oxide particles according to claim 16, wherein the step of subjecting the solid residue to the hydrothermal treatment is for a time period between 0.5 and 24 hours.
